(19) United States
(12) Patent Application Publication
(10) Pub. No.: US 2014/0156447 A1
(43) Pub. Date: Jun. 5, 2014

(54) SYSTEM AND METHOD FOR DYNAMICALLY CREATING SONGS AND DIGITAL MEDIA FOR SALE AND DISTRIBUTION OF E-GIFTS AND COMMERCIAL MUSIC ONLINE AND IN MOBILE APPLICATIONS

(71) Applicant: BUILD A SONG, INC., MISSION VIEJO, CA (US)

(72) Inventor: DAVID PACK, Mission Viejo, CA (US)

(73) Assignee: BUILD A SONG, INC., MISSION VIEJO, CA (US)

(21) Appl. No.: 14/033,387

(22) Filed: Sep. 20, 2013

Related U.S. Application Data
(60) Provisional application No. 61/703,560, filed on Sep. 20, 2012.

(51) Int. Cl. G06Q 30/06

(52) U.S. Cl. CPC G06Q 30/0621
USPC 705/26.5

(57) ABSTRACT

A method for creating a customized digital media may comprise: providing a set of original songs to a user; receiving a selection of an original song out of the set of original songs from the user, wherein the original song comprises a set of song elements and each song element comprises a music; providing a set of lyrics based on the occasion description and the original song from the user; receiving selected lyrics out of the set of lyrics from the user; receiving a selection of a music genre from the user for each song element; and creating a permutation song.

### REFERENCE TO RELATED APPLICATIONS

This application claims the benefit of U.S. Provisional Application No. 61/703,560, filed Sep. 20, 2012, the content of which is incorporated herein in its entirety.

### TECHNICAL FIELD

The present invention relates to the dynamic creation and distribution of digital media that includes building songs for e-gifts, e-greetings, entertainment, e-commerce and other internet and mobile applications.

### DESCRIPTION OF THE RELATED ART

With the advent of the internet and mobile smart phones, the distribution and commercial sale of digital media has become very popular and revolutionized the entertainment and gift industries at large. In this regard, digital media may be used instead of conventional gifts. To date, people have not created customized digital media gifts. Further, distribution of digital media has been facilitated in a number of ways such as via digital retail stores (e.g., Apple Itunes®) and online websites (e.g., Amazon.com). Generally, the same digital media is distributed across various distribution systems. For example, a song that is distributed on Apple Itunes® may also be found at Amazon.com; however, Apple Itunes® and Amazon.com may distribute the same song at different prices or in different file types (e.g., MP3, WAV, etc.) These digital media distribution systems are simply passive warehouses of digital media where consumers or artists cannot create customized songs that are based on an original song, but have different lyrics or music in different styles.

### BRIEF SUMMARY OF EMBODIMENTS OF THE INVENTION

Embodiments of the invention are directed toward a new way to create online gifts that include user-participation in highly personalizing an e-gift or e-greeting that includes building and customizing a song, and other forms of music and related media. To date people have not had the experience of building a song and customizing digital media online for gifts, e-greeting, entertainment and other purposes. One embodiment of the invention is specific to online gifts and e-greeting cards; however, further embodiments entail a broader digital distribution system that includes a new way for composers and recording artists to create songs and distribute them to music fans.

According to various embodiments of the invention, systems and methods for dynamically creating and distributing digital media are provided. Customized digital media, e.g., songs, may be created to comprise alternative lyrics or music in a different style from an original digital media. In some cases, customized digital media may be distributed with customized E-greetings, where royalties are paid to various parties such as owners of the original digital media, or artists or songwriters composing the original songs with a set of alternative lyrics. According to some embodiments, the customized digital media may comprise various song elements comprising lyrics or music in selected styles provided by one or more artists. In some embodiments, various royalty tables are created, wherein a payment is collected from a user and royalty payments are allocated according to an appropriate royalty table. In further embodiments, gifts may be sent together with the E-greeting.

In one embodiment, the process starts with the creation of a song whereby the composer writes alternate sets of song lyrics (e.g., 3 or 4 sets) for each section of a song (i.e., verse, chorus 1, verse 2, chorus 2, etc.). Subsequently, a singer sings these alternate lyrics comprising alternate lyric vocal performances and music accompaniment in different styles (e.g., orchestral, rock, folk) from the original digital media that can be offered to the consumer. Next, the composer writes alternate music beds (new music arrangements) to accompany the alternate lyrics-vocal performances, in various music styles such as rock, orchestral, folk, reggae, etc. These vocal-lyric and music-bed performances, rendered in digital audio, are then put into a proprietary numerically rendered data base system. Then, a sync-engine is used to synchronize these inputs together into a customized song in a short amount of time. As a result, the consumer-user, who was given mouse-click choices to participate in “building the song” hears the now finished song played back with all the music elements fully synchronized. That song, in one example of usage, can then become part of an e-card or e-gift that the consumer-user creates for a special occasion, personal expression or any purpose. However, as would be understood by one of ordinary skill in the art, this gift is not limited to e-cards and gift type media. This system can also comprise a new form of creating and distributing songs throughout the entire music industry, as well as game type usages, and other formats of the future.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 illustrates an exemplary system for dynamically creating and distributing digital media in accordance with one embodiment of the invention, and implemented in an environment comprising various user systems connected via a communication medium.

FIG. 2 is a flow chart illustrating an exemplary method of creating and presenting customized digital media in accordance with an embodiment of the invention.

FIG. 3 is a flow chart illustrating an exemplary method of creating and distributing customized digital media in accordance with an embodiment of the invention.

FIGS. 4A-1-4A-3 and 4B-1-4B-3 are system charts depicting an exemplary E-greeting in accordance with an embodiment of the invention.

FIGS. 4C-4E are exemplary designs of interfaces of a system for dynamically creating and distributing digital media in accordance with one or more embodiments of the invention.

FIG. 5 illustrates an example computing module that may be used in implementing various features of embodiments of the invention.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

According to various embodiments of the invention, systems and methods for dynamically creating and distributing digital media are provided. By way of example, customized E-greetings with customized digital media may be created and distributed. In some cases, royalties are paid to various parties, such as owners of the original digital media and providers of various song elements comprising music in different styles and different lyrics. In one embodiment, a customized song (which can be a permutation of an original song) may be created from selecting a music style and a set of song elements comprising different lyrics. Artists or songwriters may provide an original song with a set of alternative lyrics. In various embodiments, the customized song is created according to the occasion that the E-greeting card is used. In some embodiments, various royalty tables are created, wherein a payment is collected from a user and royalty payments are allocated according to an appropriate royalty table. In further embodiments, gifts may be chosen and sent together with the E-greeting.

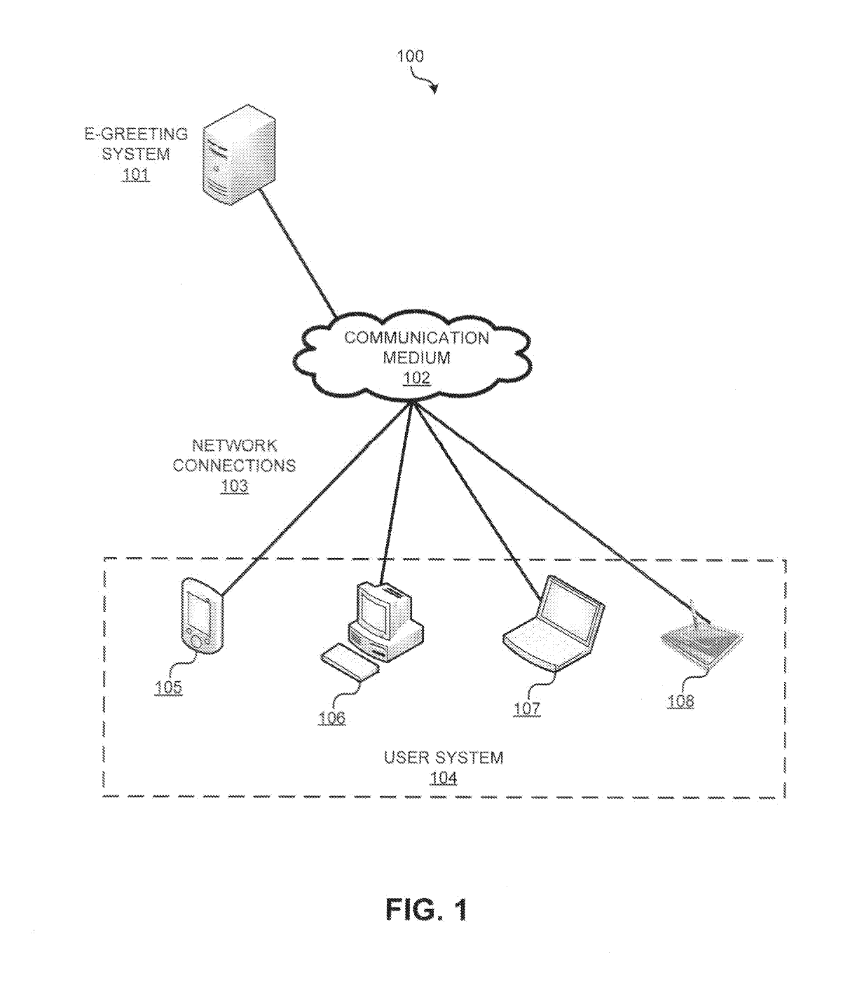

Before describing the invention in further detail, it may be useful to describe a few example environments in which various embodiments of the present invention can be implemented. One such example is that of illustrated in FIG. 1.

FIG. 1 illustrates an exemplary system 101 for dynamically creating and distributing digital media in accordance with one embodiment of the invention, and implemented in an environment 100 comprising various user systems 104 connected via a communication medium 102. In some embodiments, the communication medium may be a wired system, such as a coaxial cable system, a fiber optic cable system, an Ethernet cable system, or other similar communication medium. Alternatively, the communication medium may be a wireless network system, such as a wireless personal area network, a wireless local area network, a cellular network, or other similar communication medium.

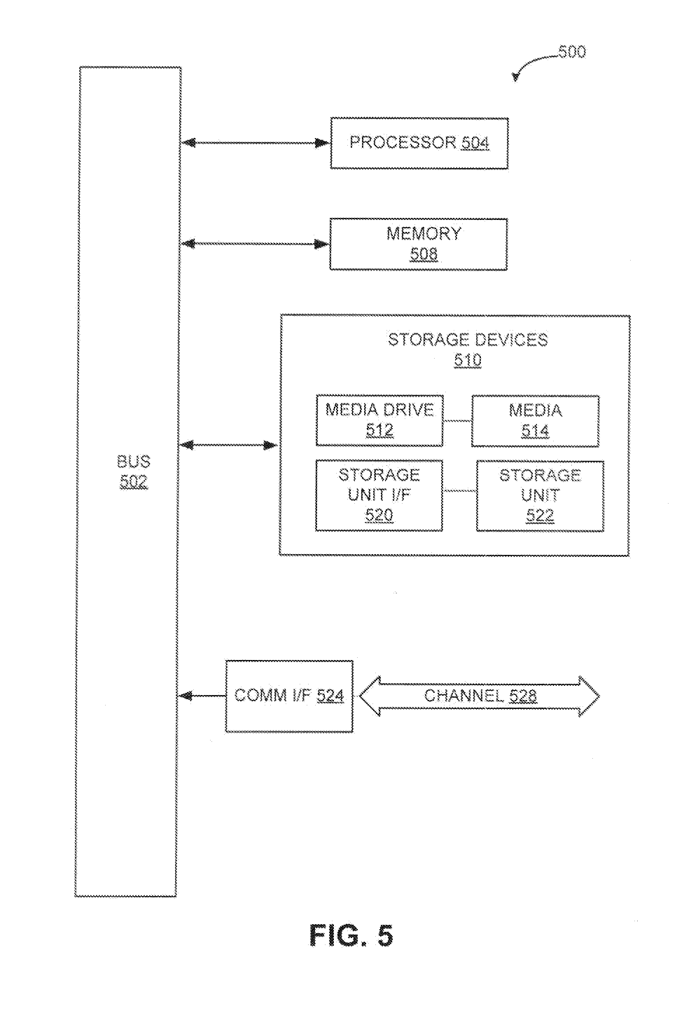

As shown, user systems 104 such as a smartphone 105 (e.g., iPhone®), a desktop computer 106, a laptop computer 107, and a tablet 108 (e.g., iPad®), through their respective network connections 103, can either interact directly or indirectly with the system 101 to dynamically create and to share a digital media, or to distribute a digital media. For example, a network connection 103 includes wired connections (e.g., Digital Subscriber Line (DSL), optical), and wireless connections (e.g., Wi-Fi.) In various embodiments, a network connection 130 may include an ad hoc network, an intranet, an extranet, a virtual private network (VPN), a local area network (LAN), a wireless LAN (WLAN), a wide area network (WAN), a portion of the Internet, a portion of the Public Switched Telephone Network (PSTN), a cellular telephone network, or any combination thereof. A network connection 130 needs not necessarily be the same throughout the environment 100. Various user systems 104 (e.g., 105, 106, 107, and 108) and the system for dynamically creating and distributing digital media (101) described herein may be implemented using the example computer system illustrated in FIG. 5.

A platform to build songs and to distribute corresponding media files can be hosted by the system 101, which may be accessed by a user using any user system 104 (e.g., 105, 106, 107, and 108). A user may be an individual or an entity. In one embodiment, two types of accounts may be created: a business account and an individual account. Users of business accounts may provide original songs, alternative lyrics, lyrics for a song element, alternative music, or music for a song element. Users of individual accounts may create a customized song from various song elements, alternative lyrics, or alternative music. A user may have an account associated with system 101, wherein the account may contain a variety of information associated with the user (e.g., the user's personal information including the person's preferred name, the username, the user's preferences, E-greeting history, media files owned by the user). The user further has a profile associated with the account. A user may have a set of friends on the system 101, and as such, the user's account may be associated with a list of friends. A user may share a media file or an E-greeting with a friend through the system 101. In various embodiments, the user may also add friends from other social media.

In various embodiments, a user may access, create, or share a customized song and E-greeting with the customized song via a user system 104. In further embodiments, a user may upload, create, and distribute a digital media via a user system 104. The user system 104 can display any interface related to the system 101. For example, the user system 104 may be configured to receive an E-greeting customization input from a user, to transmit the E-greeting customization input to the system 101, and to receive E-greeting instructions from the system 101. In one embodiment, a user may download a client component of an E-greeting such as an E-greeting card application, or a digital media distribution application. The client component may be executed locally at a user system 104, whereas the system 101 may provide back-end support for the client component and may be responsible for maintaining the E-greeting application data, processing inputs from users, updating and synchronizing displays among various users, distributing digital media, creating customized digital media, and transmitting instructions to various user system 104.

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention.

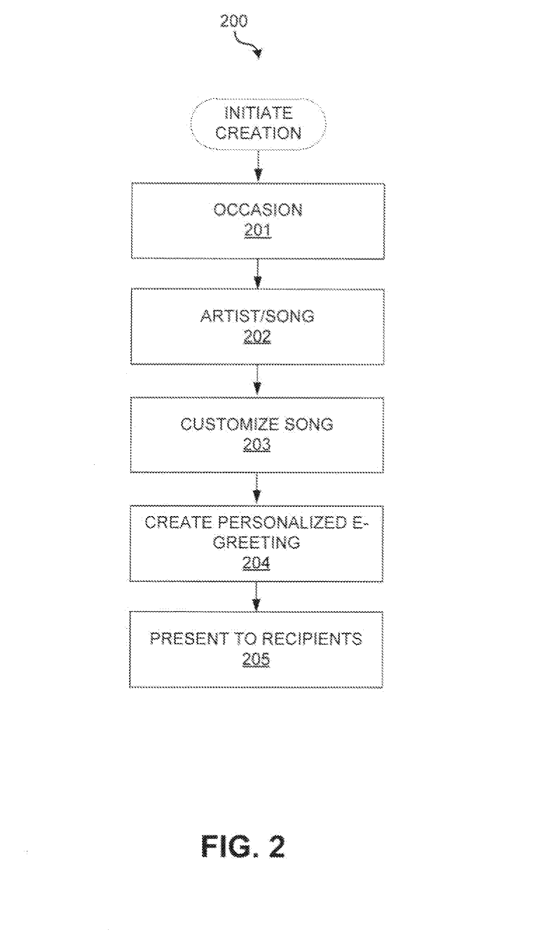

FIG. 2 is a flow chart illustrating an exemplary method 200 of creating and presenting a customized digital media in accordance with an embodiment of the methods and systems described herein. In this embodiment, the customized digital media comprises a customized E-greeting. At step 201, the method receives a selection of an occasion from a user in which the E-greeting is used. At step 202, the method presents a list of artists and a list of songs by various artists based on the selection of the occasion from the user. In some embodiments, the method presents a list of songs by an artist subsequent to the user selecting the artist from a list of artists. As different songs are suitable for various occasions, the method determines a set of songs that may be suitable for the occasion where the E-greeting card is used and presents the set of songs to the user. The user then determines and selects a song to be used in the E-greeting. In one embodiment, the user merely listens to the song. In other embodiments, the user is presented with associated song information (e.g., the artist, album, publisher, and description of the song) while listening to the song. In further embodiments, the user has the option to purchase the song in various digital formats. In various embodiments, the user may search for a particular song whether or not the particular song is included in the set of songs. If the particular song is not included in the set of songs for the occasion, the method adds the song to the set of songs that are suitable for that occasion.

At step 203, the method customizes the song according to the user's instruction regarding the music genre for a song element of the customized song, the lyrics for a song element of the customized song, and the customized song structure including the sequence of various song elements for the customized song. The method may process the original song into a sequence of song elements, such as introduction, verse, pre-chorus, chorus, bridge, middle eight, collision, and instrumental solo. In one embodiment, the method presents a sequence of song elements to the user, allows the user to select some song elements to compose the customized song, and then reorders the selected song elements. In some embodiments, the method determines a set of song elements that are suitable for the occasion and sorts the set of song elements in a predetermined order that is suitable for the occasion. Additionally, for each selected song element, the method allows the user to customize the lyrics. In one embodiment, an artist may provide a set of alternative complete lyrics for a song, wherein the method processes this into a set of lyrics for a set of selected song elements.

In one embodiment, the method determines a set of lyrics that are suitable for the occasion and the user selects lyrics out of the set of lyrics for each song element of the customized song. Further, the method may process the music for each song element into the music genre specified by the user. For example, a user may create the customized song in a folk genre even though the original song is a rock song. The method creates music that is based on the music of the original song but in the new genre, and utilizes a Sync Engine to synchronize the music with the lyrics selected by the user. The method then composites the selection of the song elements, the lyrics, and the music genre according to the sequence of song elements into a customized song. In some embodiments, the method synchronizes the lyrics with the music for each song element and composites the song elements according to a sequence. In various embodiments, the customized song is sung by the same artist who sings the original song.

Still referring to FIG. 2, at step 204, the method creates a personalized E-greeting. In one embodiment, the method determines a set of E-greeting designs that is suitable for the occasion and allows the user to make a selection. In various embodiments, the user may: upload media files including photos, videos, audios; choose or change a layout of various components of the E-greeting, and create personal messages, etc. In various embodiments, the method provides the user with a preview of the E-greeting. The method further associates the customized song with the personalized E-greeting. In some embodiments, the user may send a gift to the recipient of the E-greeting. At step 205, the method presents the E-greeting to recipients. In one embodiment, the method may notify the recipients on their respective user system. In various embodiments, the method notifies the recipients in their respective account on the system 101. In further embodiments, the recipients may be notified by emails, SMSs, text messages, or notifications on various social media. In one embodiment, the customized song may be stored on the system under the user's account and the customized song may be retrieved in the future. In some embodiments, a recipient may further share the personalized E-greeting and the customized song with new recipients. In various embodiments, the method calculates a payment and collects the payment from the user prior to step 205. The method pays a royalty to the owner(s) of the original song and/or artists providing music and lyrics for the song elements.

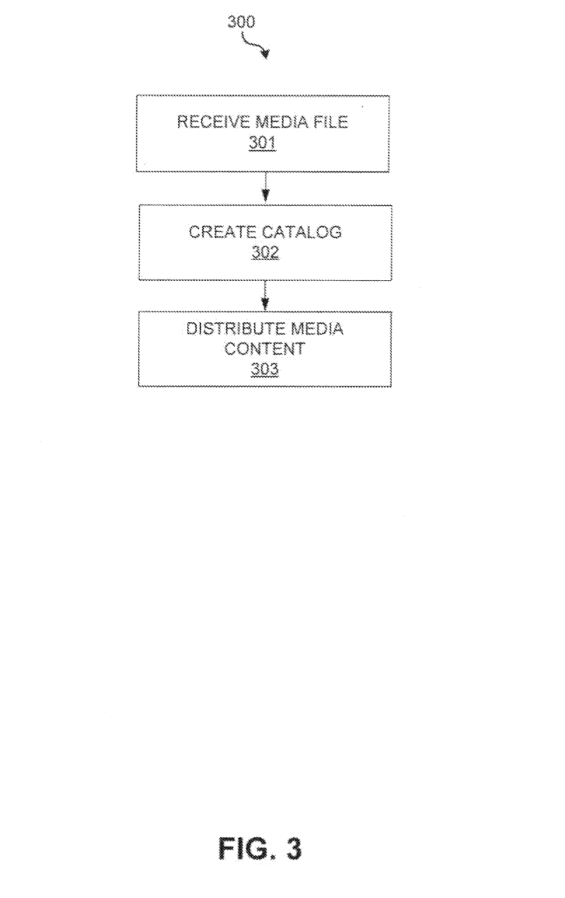

FIG. 3 is a flow chart illustrating an exemplary method 300 of creating and distributing customized digital media in accordance with an embodiment of the methods and systems described herein. At step 301, the method receives a media file from a user (e.g., a songwriter, recording artist). In various embodiments, a user having a business account on the system 101 may be eligible to submit media files for distribution. A user with a business account may be an artist who creates music and/or lyrics of the original song as well as for various song elements. A business account may include additional sub-types, and each sub-type is related to a royalty payment program. The method provides the user with options to create media content in connection with the media file that may be distributed. In one embodiment, the method provides the user with options to create music content for use in an E-greeting. Examples of options provided are description of occasions that the media file may be used, identification of song elements, the appropriate starting and end time of song elements, a sequence of song elements for a particular occasion, lyrics for a particular occasion.

At step 302, the method creates a catalog for each type of media content included in the media file. A catalog facilitates distribution of the media content. For example, a catalog may include the media file of a song, metadata of the song (e.g., author, album, song genre, description, lyrics), song characteristics information (e.g., suitable occasion, group association, publisher, label, and charity, time of various song elements), and a royalty table. The royalty table provides for the calculation of royalty. In one embodiment, the method provides a platform where various users may collaborate on creating the catalog. At step 303, the method distributes the media content according to the catalog and pays royalty accordingly. In one embodiment, the method distributes the media content by allowing a user to create a customized song or other digital media and to use the customized digital media with a customized E-greeting. In one embodiment, the method publishes the media content and the catalog. In one embodiment, the method distributes the royalty by sending a payment to appropriate accounts.

FIGS. 4A-1-4A3 is a system chart depicting an exemplary system 400 for dynamically creating and distributing digital media in accordance with an embodiment of the methods and systems described herein. In the illustrated example, the system 400 comprises an application programming interface (API) where a user may access the system. A user includes an individual or an entity. The exemplary interface also provides advertising and gift partner content. In the illustrated example, the system 400 comprises a content management system where all the input from API is processed. In the illustrated example, the system 400 comprises software applications that: (i) host the system; (ii) process registration and log in, search, creation of E-greetings; and (iii) support various mobile applications and maintenance of accounts. Further, the system 400 comprises an output where the E-greetings are distributed.

FIGS. 4B-1-4B-3 is a system chart depicting an exemplary system 410 for dynamically creating and distributing digital media in accordance with an embodiment of the invention. In particular, the system 410 comprises an API where a user (e.g., an individual or an entity) may access the system. In the illustrated example, the system 410 comprises a content management system where all the input from API is processed. Additionally, the system 400 comprises software applications that: (i) host the E-greeting with buildable song system; (ii) process registration and log in; and (iii) promote digital media, manages songs, and process business finance reports. Further, the system 410 comprises an output where the songs are distributed.

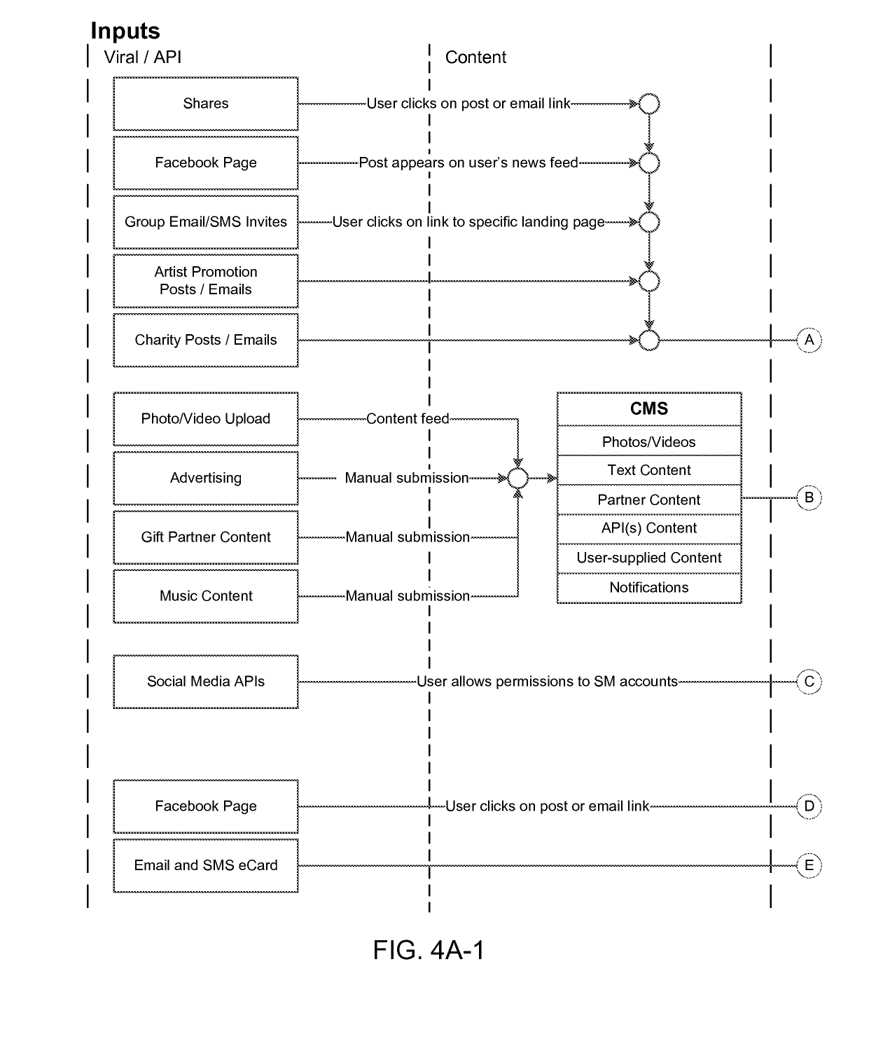

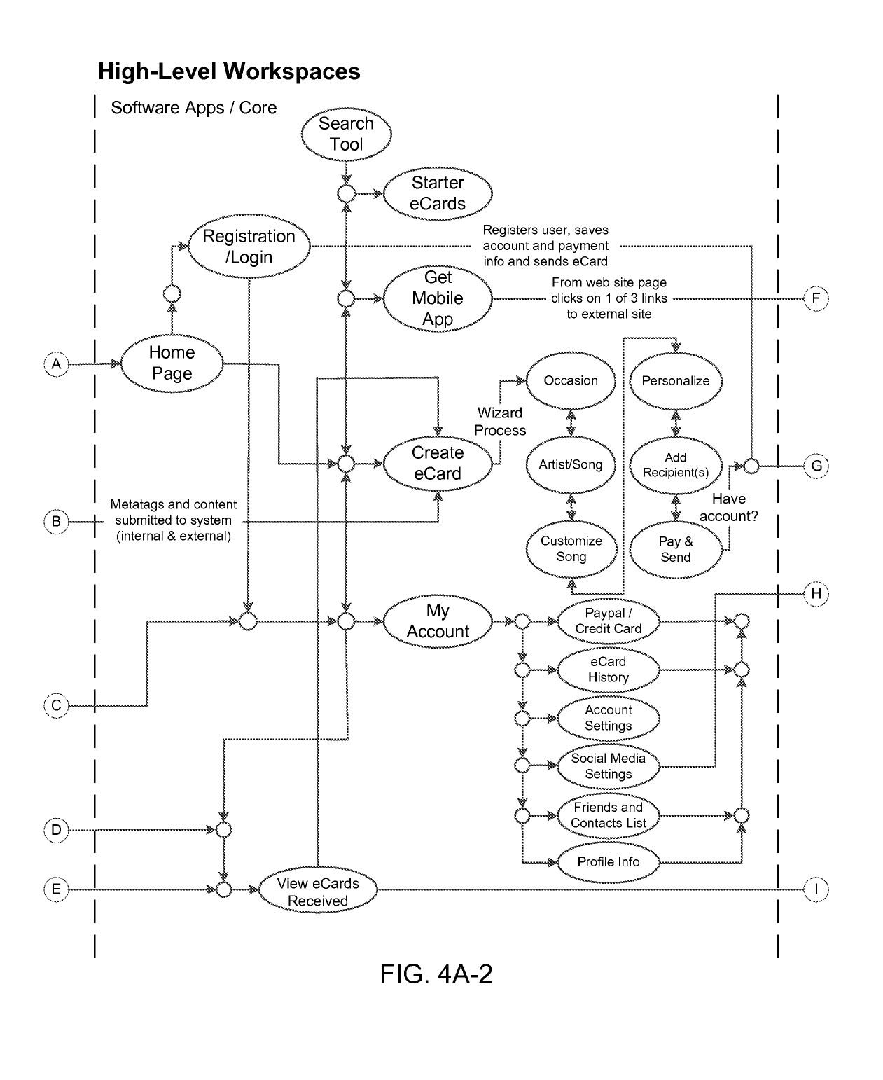

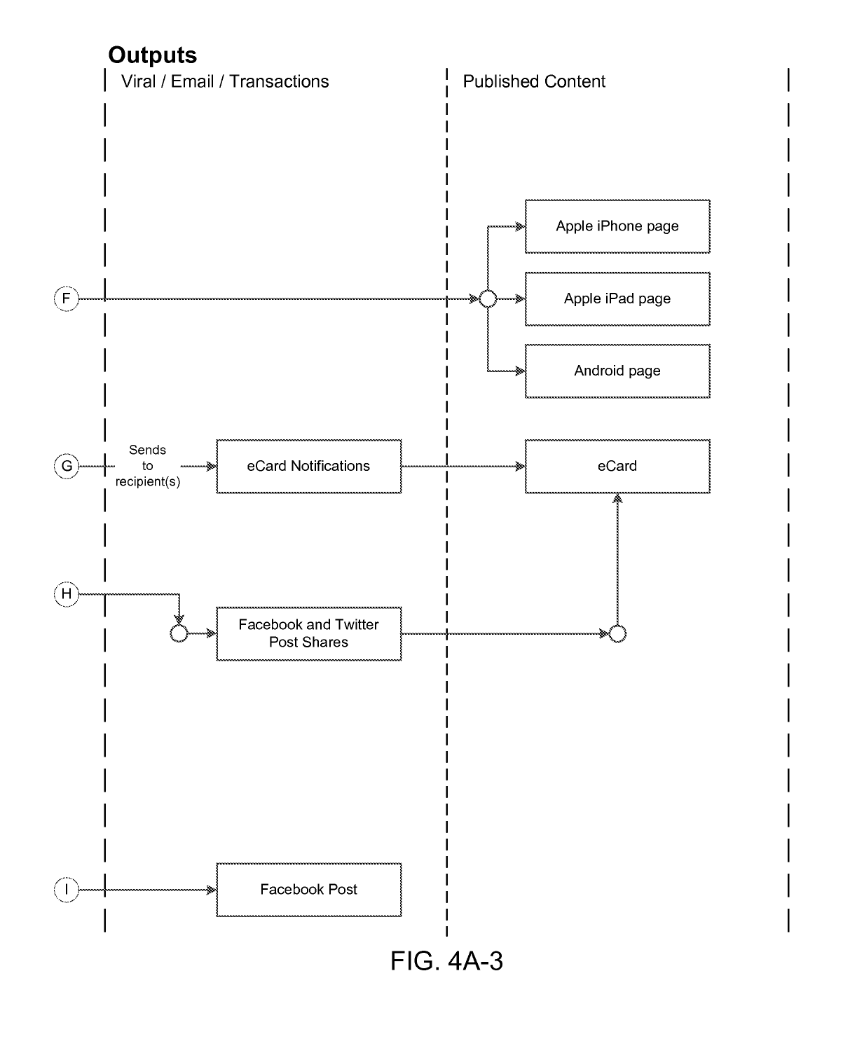

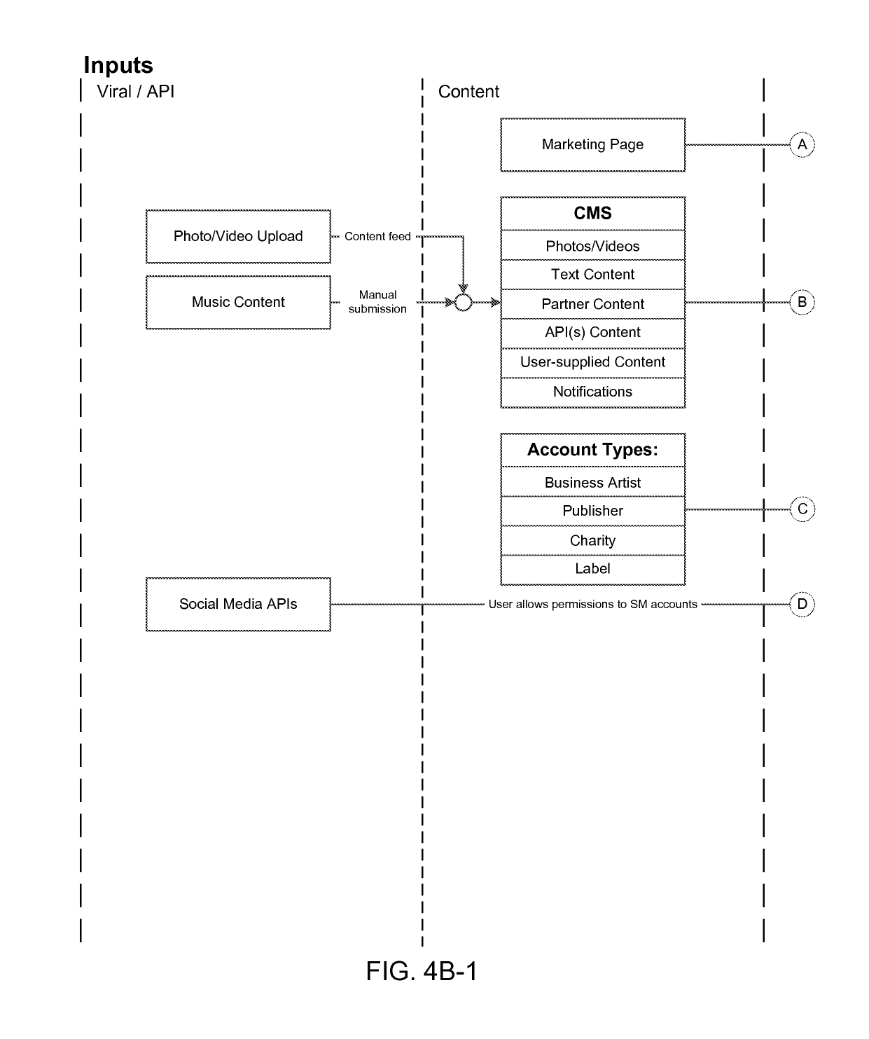

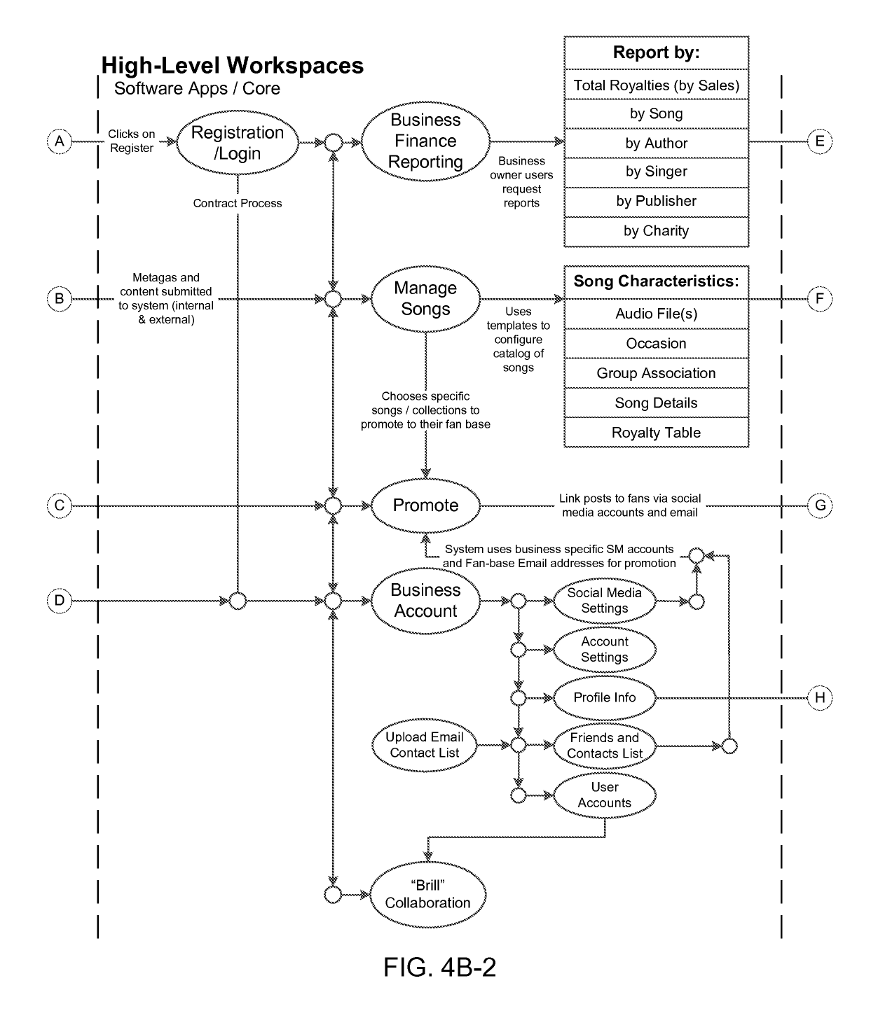

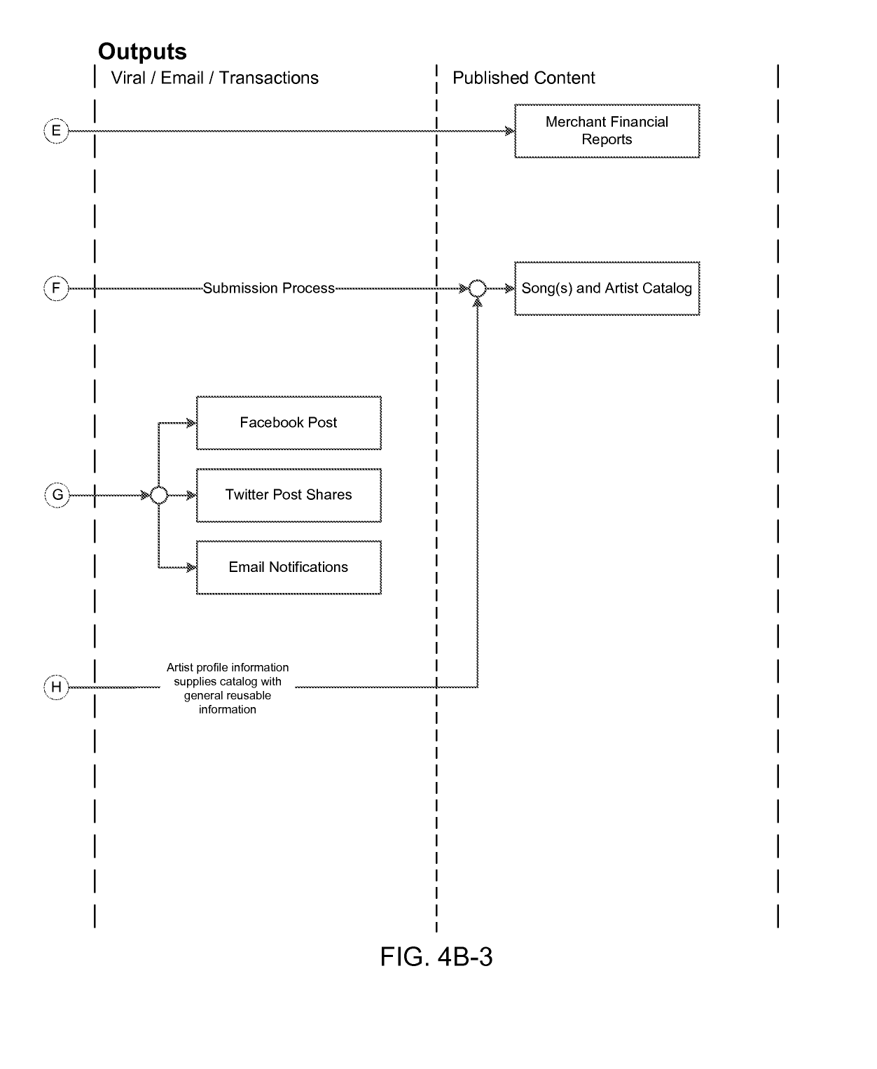

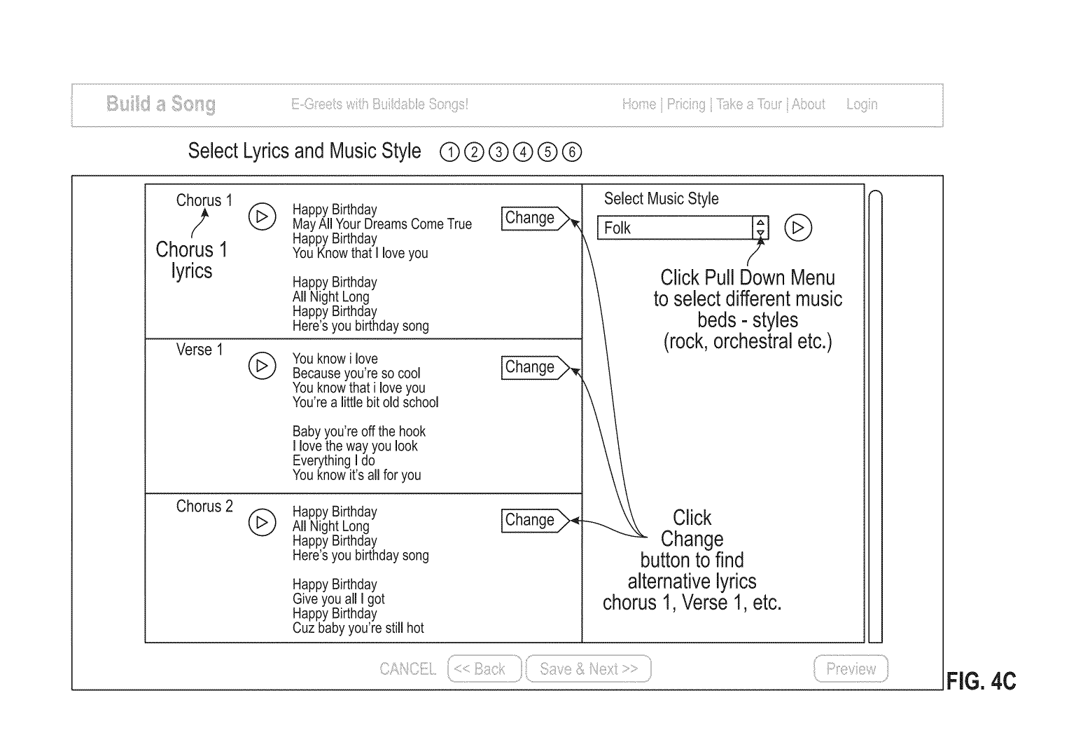

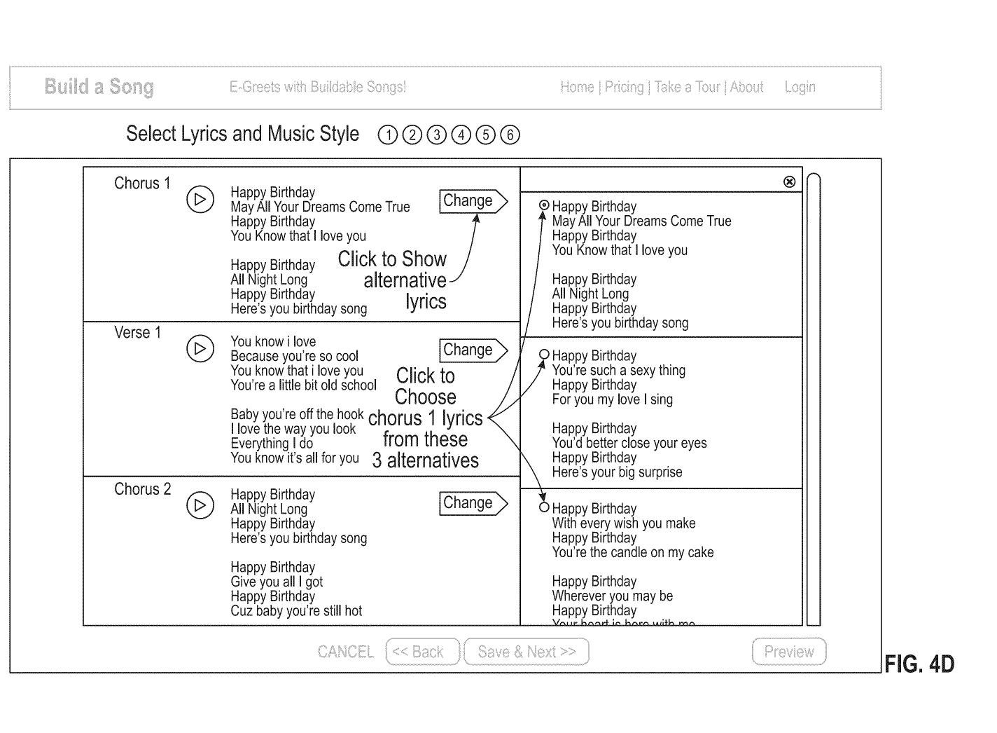

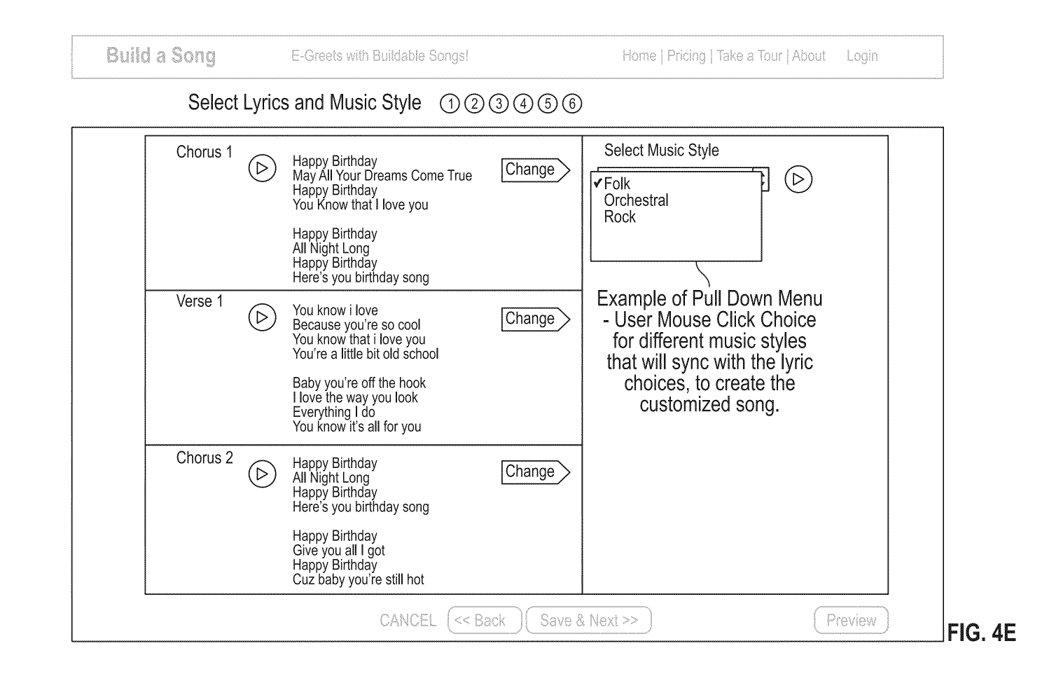

FIGS. 4C-4E are exemplary designs of a system interface in accordance with one or more embodiments of the methods and systems described herein. Referring to FIGS. 4C and 4D, the user is prompted to select lyrics and music style. As illustrated, an initial set of lyrics is provided for Chorus 1. However, the user can click the Change button to display one or more sets of alternate lyrics for Chorus 1 for selection by the user (see FIG. 4D). Similarly, an initial set of lyrics is also provided for Verse 1 and Chorus 2. The user can click the appropriate Change button to display one or more sets of alternate lyrics for Verse 1 and Chorus 2 for selection by the user. A pull down menu is provided for selection of the music style, which is set to Folk in FIG. 4C. The user can click the pull down menu to select an alternate music style such as Folk, Orchestral, etc, as depicted in FIG. 4E.

As used herein, the term set may refer to any collection of elements, whether finite or infinite. The term subset may refer to any collection of elements, wherein the elements are taken from a parent set; a subset may be the entire parent set. As used herein, the term module might describe a given unit of functionality that can be performed in accordance with one or more embodiments of the present invention. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the invention are implemented in whole or in part using software, in one embodiment, these software elements can be implemented to operate with a computing or processing module capable of carrying out the functionality described with respect thereto. One such example computing module is shown in FIG. 5. Various embodiments are described in terms of this example-computing module 500. After reading this description, it will become apparent to a person skilled in the relevant art how to implement the invention using other computing modules or architectures.

Referring now to FIG. 5, computing module 500 may represent, for example, computing or processing capabilities found within desktop, laptop and notebook computers; hand-held computing devices (PDA's, smart phones, cell phones, palmtops, etc.); mainframes, supercomputers, workstations or servers; or any other type of special-purpose or general-purpose computing devices as may be desirable or appropriate for a given application or environment. Computing module 500 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 500 might include, for example, one or more processors, controllers, control modules, or other processing devices, such as a processor 504. Processor 504 might be implemented using a general-purpose or special-purpose processing engine such as, for example, a microprocessor, controller, or other control logic. In the illustrated example, processor 504 is connected to a bus 502, although any communication medium can be used to facilitate interaction with other components of computing module 500 or to communicate externally.

Computing module 500 might also include one or more memory modules, simply referred to herein as main memory 508. For example, preferably random access memory (RAM) or other dynamic memory, might be used for storing information and instructions to be executed by processor 504. Main memory 508 might also be used for storing temporary variables or other intermediate information during execution of instructions to be executed by processor 504. Computing module 500 might likewise include a read only memory (“ROM”) or other static storage device coupled to bus 502 for storing static information and instructions for processor 504.

The computing module 500 might also include one or more various forms of information storage mechanism 510, which might include, for example, a media drive 512 and a storage unit interface 520. The media drive 512 might include a drive or other mechanism to support fixed or removable storage media 514. For example, a hard disk drive, a floppy disk drive, a magnetic tape drive, an optical disk drive, a CD or DVD drive (R or RW), or other removable or fixed media drive might be provided. Accordingly, storage media 514 might include, for example, a hard disk, a floppy disk, magnetic tape, cartridge, optical disk, a CD or DVD, or other fixed or removable medium that is read by, written to or accessed by media drive 512. As these examples illustrate, the storage media 514 can include a computer usable storage medium having stored therein computer software or data.

In alternative embodiments, information storage mechanism 510 might include other similar instrumentalities for allowing computer programs or other instructions or data to be loaded into computing module 500. Such instrumentalities might include, for example, a fixed or removable storage unit 522 and an interface 520. Examples of such storage units 522 and interfaces 520 can include a program cartridge and cartridge interface, a removable memory (for example, a flash memory or other removable memory module) and memory slot, a PCMCIA slot and card, and other fixed or removable storage units 522 and interfaces 520 that allow software and data to be transferred from the storage unit 522 to computing module 500.

Computing module 500 might also include a communications interface 524. Communications interface 524 might be used to allow software and data to be transferred between computing module 500 and external devices. Examples of communications interface 524 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 524 might typically be carried on signals, which can be electronic, electromagnetic (which includes optical) or other signals capable of being exchanged by a given communications interface 524. These signals might be provided to communications interface 524 via a channel 528. This channel 528 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium,” “computer readable medium,” and “computer usable medium” are used to generally refer to media such as, for example, memory 508, storage unit 520, media 514, and channel 528. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 500 to perform features or functions of the present invention as discussed herein.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A non-transitory computer readable medium having computer executable program code embodied thereon, the computer executable program code configured to cause a computing device to create a customized digital media by:
providing a set of original songs to a user;
receiving a selection of an original song out of the set of original songs from the user, wherein the original song comprises a set of song elements and each song element comprises a music;
providing a set of lyrics based on the occasion description and the original song from the user;
receiving selected lyrics out of the set of lyrics from the user;
receiving a selection of a music genre from the user for each song element; and
creating a permutation song.

2. The computer readable medium of claim 1, wherein the set of original songs is based on an occasion description provided by the user.

3. The computer readable medium of claim 1, wherein creating a permutation song comprises sequencing and compositing the set of song elements with the lyric received from the user to create the permutation song based on the original song.

4. The computer readable medium of claim 1, further comprising associating the permutation song with an E-greeting card customized by the user.

5. A non-transitory computer readable medium having computer executable program code method for creating a customized digital media, comprising:
providing a set of original songs to a user;
receiving a selection of an original song out of the set of original songs from the user, wherein the original song comprises a set of song elements and each song element comprises a music;
providing a set of lyrics based on the occasion description and the original song from the user;
receiving selected lyrics out of the set of lyrics from the user;
receiving a selection of a music genre from the user for each song element; and
creating a permutation song.

6. The computer readable medium of claim 5, wherein the set of original songs is based on an occasion description provided by the user.

7. The computer readable medium of claim 5, wherein creating a permutation song comprises sequencing and compositing the set of song elements with the selected lyrics received from the user to create a permutation song based on the original song.

8. The computer readable medium of claim 5, further comprising associating the permutation song with an E-greeting card customized by the user.

9. A non-transitory computer readable medium having computer executable program code embodied thereon, the computer executable program code configured to cause a computing device to distribute a customized digital media by:
receiving a first media file from a user;
processing the media file;
creating a second media file; and
distributing the first media file and the second media file according to a set of distribution rules.

10. The computer readable medium of claim 9, wherein the media file comprises an original song and metadata associated with the original song.

11. The computer readable medium of claim 10, wherein the original song comprises original music and original lyrics.

12. The computer readable medium of claim 11, wherein processing the media file comprises processing the original song into a set of song elements and the original music into a set of music, each music of the set of music having a music genre.

13. The computer readable medium of claim 12, further comprising associating a set of lyrics with each song element based on an occasion.

14. The computer readable medium of claim 13, wherein creating a second media file comprises creating a second song according to user's selection of a music genre and selected lyrics of the set of lyrics for each song element.

15. The computer readable medium of claim 14, wherein distributing the first media file and the second media file according to a set of distribution rules comprises distributing the first song and the second song according to a set of distribution rules.
